(19) United States
(12) Patent Application Publication
(10) Pub. No.: US 2011/0012910 A1
(43) Pub. Date: Jan. 20, 2011

(54) MOTION FIELD TEXTURE SYNTHESIS

(75) Inventors: Li-Yi Wei, Redwood City, CA (US); Chongyang Ma, Beijing (CN); Baining Guo, Beijing (CN); Kun Zhou, Hangzhou (CN)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/503,162

(22) Filed: Jul. 15, 2009

(51) Int. Cl. G06T 15/70; G09G 5/00

(52) U.S. Cl. 345/582; 345/474

(57) ABSTRACT

A system is described for using a texture synthesis approach to produce digital images that simulate motion. The system operates by receiving a large-scale motion image that describes large-scale motion, as well as one or more exemplar images that describes small-scale motion. The system then applies a texture synthesis approach to duplicate the small-scale motion described in the exemplar image(s), as guided by the large-scale motion described in the large-scale motion image. This operation produces a synthesized motion image. The system then combines the synthesized motion image with the large-scale motion image to produce a combined motion image. The combined motion image presents the large-scale motion as modulated by the small-scale motion. The system can also take account for one or more application-specific constraints, such as incompressibility and boundary conditions.

### BACKGROUND

Various phenomena include detailed motion fields that can be modeled by repetitive structures. Examples of such phenomena include fluid motion, smoke motion, herd and group behavior, repetitive behavior of a single entity, and so forth. A computer application which depicts these phenomena will therefore seek to realistically simulate the detailed motion fields. Such computer applications include computer games, computer simulation, computer enhancement or restoration of video content, and so forth.

One technique for generating images which depict detailed motion is physics simulation. Physics simulation uses one or more equations which describe the underlying physical behavior of the phenomena. Another technique is procedural simulation, such as procedural texturing. Procedural simulation uses various algorithms to generate the detailed motion (without necessarily attempting to duplicate the underlying physics of the phenomena). Another technique is manual creation. Manual creation relies on a user to manually specify the detailed motion.

The above-described simulation approaches are sometimes successful in realistically simulating the phenomena. But these approaches may also have one or more drawbacks. For example, the approaches: a) may be relatively complex, and therefore may be difficult to develop; b) may be time-consuming or cumbersome to run; c) may be difficult to control; d) may have limited flexibility and applicability (e.g., generality); and/or e) may provide results having unreliable quality, etc.

### SUMMARY

According to one illustrative implementation, functionality is described for using a texture synthesis approach to produce digital images that simulate motion. The functionality operates by receiving a large-scale motion image L that describes large-scale motion, as well as one or more exemplar images {Iᵢ} that describes small-scale motion. The functionality then applies a texture synthesis approach to duplicate the small-scale motion described in the exemplar image(s) {Iᵢ}, as guided by the large-scale motion described in the large-scale motion image L. This operation produces a synthesized motion image H. The functionality then combines the synthesized motion image H with the large-scale motion image L to produce a combined motion image F. The combined motion image F presents the large-scale motion as modulated by the small-scale motion. The functionality then displays the combined motion image F within the context of any computer-implemented application that simulates motion, such as a game application, a simulation application, a video application, etc.

In one illustrative aspect, the large-scale motion image L describes a large-scale flow of a material (such as liquid, smoke, etc.). In another case, the large-scale motion image L describes a large-scale movement of a population of entities, and so on.

According to another illustrative aspect, in performing texture synthesis, the functionality addresses particular considerations which apply to the synthesis of motion information (as opposed to color information). For example, the functionality can perform coordinate transformation after orienting local instances of the small-scale motion within a global flow defined by the large-scale motion. The functionality can also perform motion vector projection to modify the operation of a neighborhood search technique that is used to perform texture synthesis.

According to another illustrative aspect, the functionality can combine the synthesized motion image H with the large-scale image L based on a combination parameter ω. The combination parameter ω influences an extent to which the small-scale motion affects the large-scale motion.

According to another illustrative aspect, in a post-processing operation, the functionality can modify the combined motion image F based on at least one application-specific constraint. In one case, the application-specific constraint pertains to incompressibility of a phenomenon being simulated (such as fluid flow). In another example, the application-specific constraint pertains to a boundary condition which affects a phenomenon being simulated. In another implementation, the texture synthesis operation can be modified to address one or more application-specific constraints (such as a boundary condition) as an integral part of its operation.

The above functionality can be manifested in various types of systems, components, methods, computer readable media, data structures, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an illustrative motion synthesis system for applying a texture synthesis operation to motion information.

FIGS. 2 and 3 show an example of the operation of the motion synthesis system of FIG. 1; in this case, the motion synthesis system generates output information that has the same dimension (e.g., 2D) as the input information that is supplied to the motion synthesis system.

FIG. 4 shows another example of the operation of the motion synthesis system of FIG. 1; in this case, the motion synthesis system generates output information that has a different dimension (e.g., 3D) compared to the input information (which may comprise one or more 2D exemplar images).

FIG. 5 shows another example of the application of the motion synthesis system of FIG. 1; in this case, the motion synthesis system performs post-processing on the output information to account for a boundary condition.

FIG. 6 is a graphical depiction of a manner in which the motion synthesis system performs a coordinate transformation operation after generating a synthesized motion image.

FIG. 7 is a graphical depiction of a manner in which the motion synthesis system projects motion vector information in conjunction with performing a neighborhood search technique.

FIG. 8 is a graphical depiction of frames of reference in which the motion synthesis system performs a neighborhood search technique with respect to 2D output information and with respect to 3D output information.

FIGS. 9 and 10 together describe a process that can be used by the motion synthesis system of FIG. 1 to perform its functions.

FIG. 11 provides an illustrative flowchart that explains one manner of operation of the motion synthesis system of FIG. 1.

FIG. 12 shows illustrative processing functionality that can be used to implement any aspect of the features shown in the foregoing drawings.

FIG. 13 depicts a texture synthesis operation used to generate a 2D texture based on a 2D exemplar image.

FIG. 14 depicts a texture synthesis operation used to generate a texture that is constrained to follow identified motion vectors along a curved surface.

FIG. 15 depicts a texture synthesis operation used to create a solid texture based on one or more 2D exemplar images.

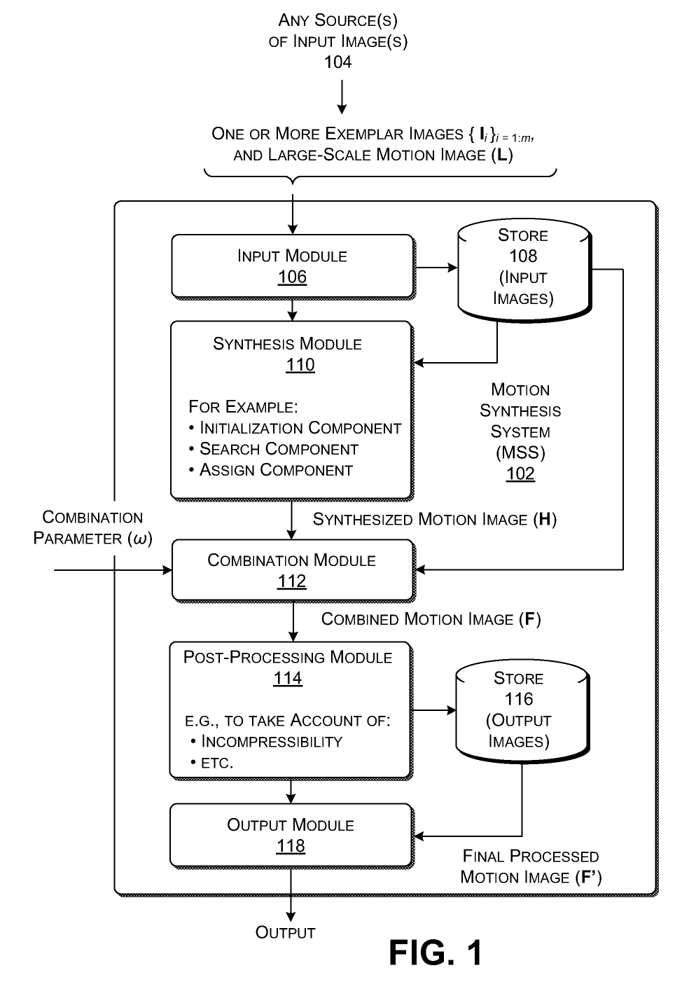

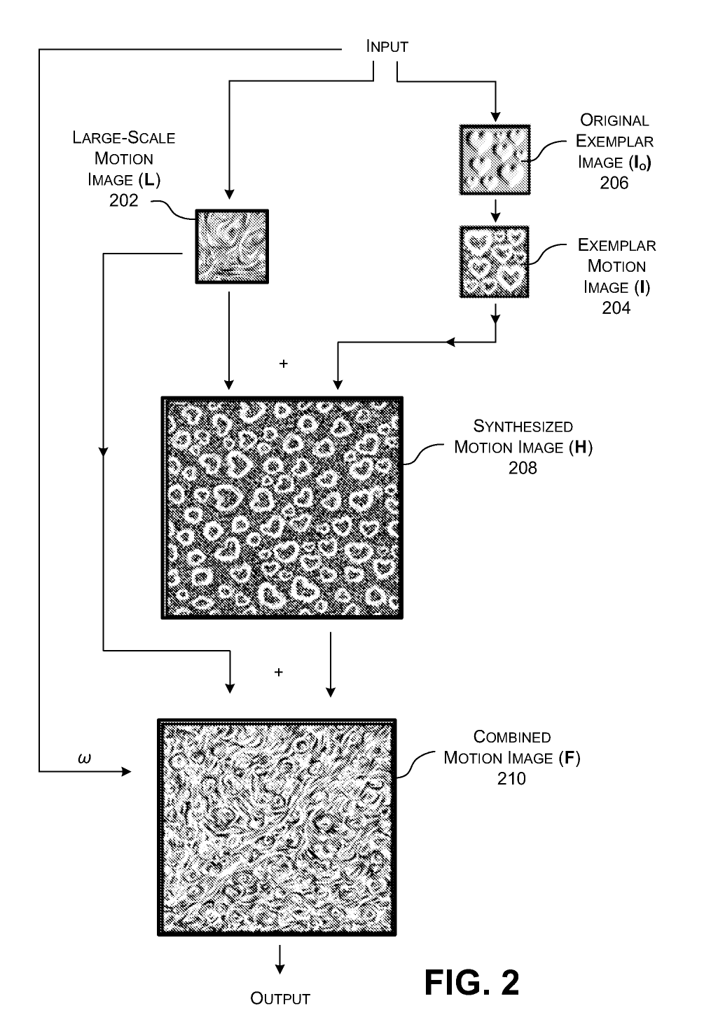

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure sets forth functionality for using a texture synthesis approach to combine small-scale motion defined by one or more exemplar images with large-scale motion defined a large-scale motion image.

This disclosure is organized as follows. Section A provides preliminary information regarding texture synthesis concepts as applied to the processing of color information within images. Section B describes an illustrative motion synthesis system for applying a texture synthesis approach to synthesis motion information. Section C describes illustrative methods which explain the operation of the system of Section B. Section D describes illustrative processing functionality that can be used to implement any aspect of the features described in Sections B and C.

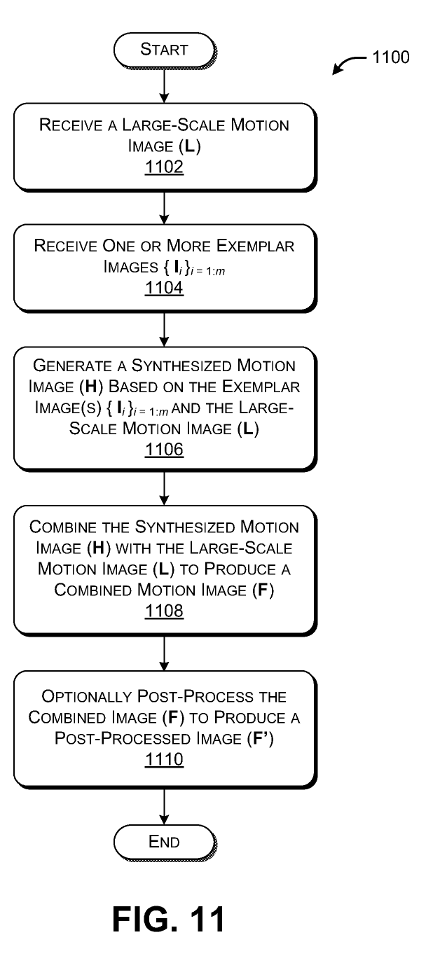

As a preliminary matter, some of the figures describe concepts in the context of one or more structural components, variously referred to as functionality, modules, features, elements, etc. The various components shown in the figures can be implemented in any manner, for example, by software, hardware (e.g., discrete logic components, etc.), firmware, and so on, or any combination of these implementations. In one case, the illustrated separation of various components in the figures into distinct units may reflect the use of corresponding distinct components in an actual implementation. Alternatively, or in addition, any single component illustrated in the figures may be implemented by plural actual components. Alternatively, or in addition, the depiction of any two or more separate components in the figures may reflect different functions performed by a single actual component. FIG. 12, to be discussed in turn, provides additional details regarding one illustrative implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented by software, hardware (e.g., discrete logic components, etc.), firmware, manual processing, etc., or any combination of these implementations.

As to terminology, the phrase “configured to” encompasses any way that any kind of functionality can be constructed to perform an identified operation. The functionality can be configured to perform an operation using, for instance, software, hardware (e.g., discrete logic components, etc.), firmware etc., and/or any combination thereof.

The term “logic component” encompasses any functionality for performing a task. For instance, each operation illustrated in the flowcharts corresponds to a logic component for performing that operation. An operation can be performed using, for instance, software, hardware (e.g., discrete logic components, etc.), firmware, etc., and/or any combination thereof. When implemented by a computing system, a logic component represents an electrical component that is a physical part of the computing system, however implemented.

A. Preliminary Discussion of Texture Synthesis Performed with Respect to Color Information

By and large, texture synthesis techniques were developed for application to color information within images. Before describing the application of texture synthesis techniques to motion information, this section presents an overview of the application of texture synthesis techniques to color information.

A texture refers to a digital image having any kind of repetitive content. In a common use, a computer-implemented application may provide a polygonal model which describes a feature within a simulated environment, such as a character within a game. The application may metaphorically “paste” a texture onto the polygonal model to produce a more realistic feature, such as by applying a brick pattern to a wall, a metal chink pattern to armor, and so on.

In a common approach, an application provides an exemplar image which provides a sample of the pattern to be applied to an output field. The application applies texture synthesis to duplicate the pattern over the output field. The output field is typically larger than the exemplar image. Hence, texture synthesis essentially populates the output field with the sample pattern provided by the exemplar image, producing a seamless extension of the exemplar image. An overview of texture synthesis techniques can be found in Wei et al., “State of the Art in Example-based Texture Synthesis,” Eurographics 2009, Munich Germany.

More formally stated, an exemplar image is a suitable candidate for texture synthesis if it can be characterized as: (1) stationary; and (2) local. To explain this concept, consider a window that can be moved over the surface of the exemplar image, at any time defining a group of neighboring pixels that are enclosed by the window. An exemplar image can be characterized as stationary if the image content that is revealed by the window is similar for different placements of the window. An exemplar image can be characterized as local if the image content that is revealed by the window can be predicted on the basis of pixels encompassed by the window, without regard to other portions of the exemplar image.

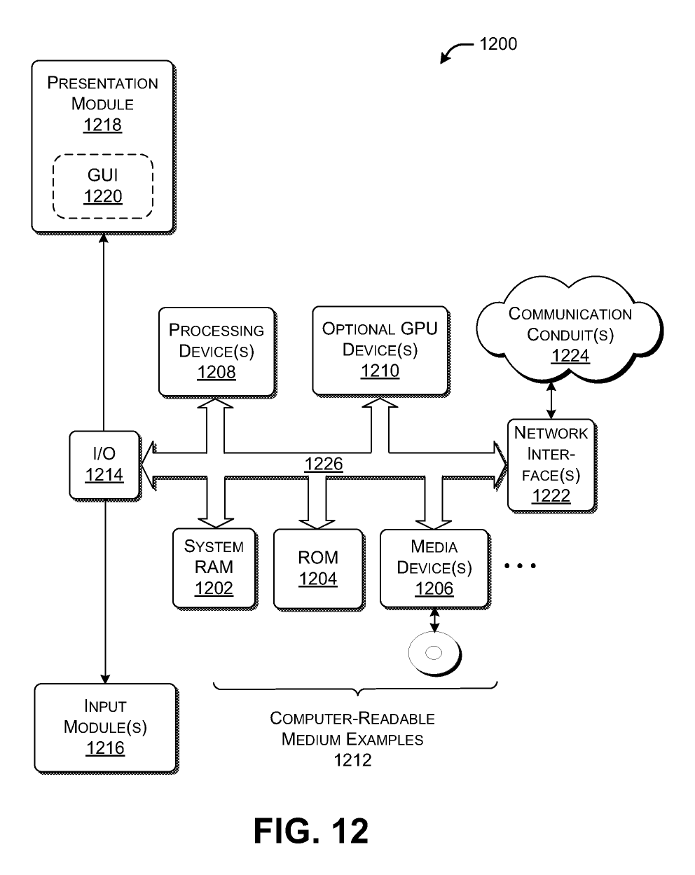

FIG. 13 shows one way of using an exemplar image 1302 to synthesize an output image 1304, as described, for example, in Li-Yi Wei, “Texture Synthesis by Fixed Neighborhood Searching,” PhD thesis, Stanford University, 2002. In this case, the exemplar image 1302 and the output image 1304 have the same dimension, namely 2D. Consider an illustrative output pixel to be synthesized in the output image 1304. In a search operation, the technique forms an output neighborhood 1306 about the output pixel. The output neighborhood 1306 includes a group of pixels that are neighbors to the output pixel. The technique attempts to find an input neighborhood 1308 in the exemplar image 1302 which is most similar to the output neighborhood 1306. In a copy operation, the technique can generate a pixel value based on the pixels in the input neighborhood 1308. The technique can then use this value to define the output pixel in the output image 1304. This process can be repeated for other output pixels to duplicate repetitive content in the exemplar image 1302 over the entire output image 1304.

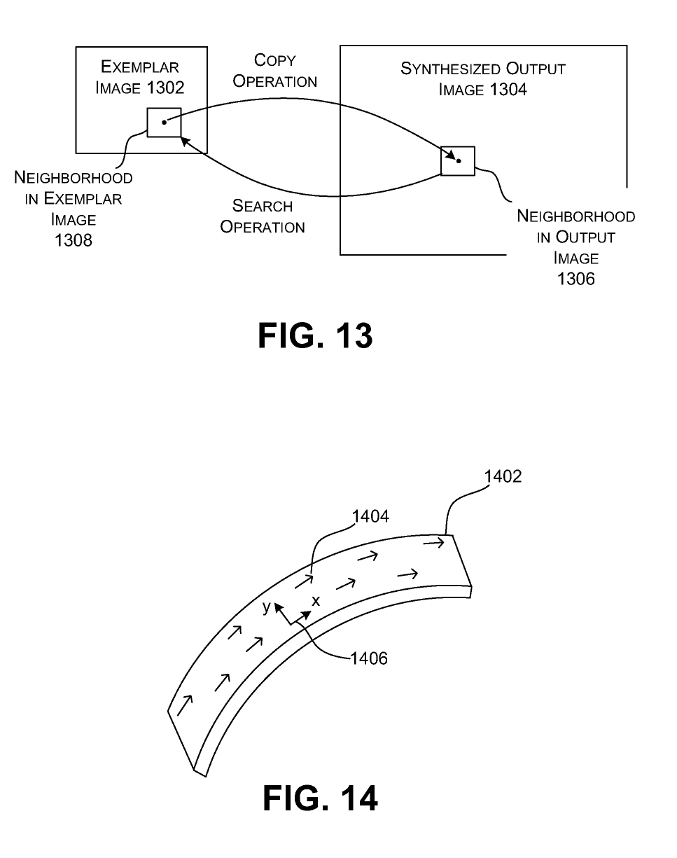

The basic technique shown in FIG. 13 can be varied and extended in a number of ways. FIG. 14, for example, shows a technique for synthesizing an output image over the surface of an object 1402; for example, the object 1402 may represent a curved surface defined by a polygonal model. In this technique, a user can manually annotate the surface of the object 1402 by specifying vector information at sparse locations on the surface. Based on this information, the technique can create a vector field 1404. The vector field 1404 defines local frames of reference on the surface of the object 1402, such as local frame of reference 1406. The technique can then perform texture synthesis with respect to the local frames of reference, e.g., by effectively orienting the repetitive content in the exemplar image with respect to the local frames of references. Note, for example, Greg Turk, “Texture Synthesis on Surfaces,” Proceedings of the 28th Annual Conference on Computer Graphics and Interactive Techniques,” 2001, pp. 347-354.

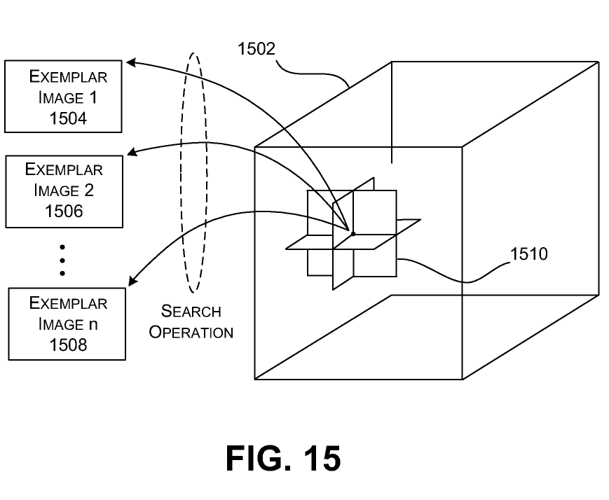

FIG. 15 shows a technique in which texture synthesis is applied throughout a solid object 1502. In other words, this technique generates texture information which permeates the object 1502. As such, if a cross section of the object 1502 is taken, the texture information will be visible within the interior of the object 1502; further, the texture information within the interior of the object will be seamlessly integrated with the texture information which is visible on the surface of the object.

One technique for applying texture synthesis to a solid object is described in Li-Yi Wei, “Texture Synthesis by Fixed Neighborhood Searching,” PhD thesis, Stanford University, 2002. This technique provides two or more 2D exemplar images (1504, 1506, . . . 1508) that are associated with different respective views of the object 1502. For instance, in one case, the technique can associate three exemplar images with three respective orthogonal views of the object 1502. Consider an illustrative output voxel to be synthesized in the object 1502. In a search operation, this technique defines a collection of output neighborhoods 1510 associated with the output voxel. The output neighborhoods 1510 correspond to different respective views (corresponding, in turn, to the views associated with the exemplar images). The technique then independently performs the type of search operation described above (with respect to FIG. 13) for the output neighborhoods vis-á-vis respective input neighborhoods in the plurality of exemplar images (1504, 1506, . . . 1508). In a copy operation, the technique can generate a voxel value based on the matching input neighborhoods produced by the search operation, e.g., by averaging values obtained from different matching input neighborhoods. The technique can use this voxel value to define the output voxel in the object 1502. The technique can repeat this process for other output voxels to synthesize texture information for the entire object 1502. Further, the technique can iterate this process one or more times with respect to the object 1502 as a whole. Variations of this technique are described in Kopf et al., “Solid Texture Synthesis from 2D Exemplars,” International Conference on Computer Graphics and Interactive Techniques, 2007, and Dong et al., “Lazy Solid Texture Synthesis,” Eurographics 2008, Crete, Greece.

A number of techniques perform matching analysis on a global (image-wide) basis, rather than in local piecemeal fashion, and thus offer a more optimized approach to texture synthesis. One such approach is described in Kwatra et al., “Texture Optimization for Example-based Synthesis,” Proceedings of ACM SIGGRAPH 2005, Vol., Issue 3, 2005, pp. 795-802. This approach models the matching analysis as an iterative algorithm. The algorithm is akin to the Expectation-Maximization (EM) approach in that it minimizes an energy function over several iterations.

A number of techniques have been developed to accelerate texture synthesis operations. One such technique is tree-structured vector quantization (TSVQ). This approach involves constructing a hierarchically structured codebook. Another technique is k-coherence. This approach involves analyzing exemplar images in advance of the search operation to construct similarity sets for each input element within the exemplar image(s). The search operation uses these similarity sets to expedite its matching analysis. Note, for example, Han et al., “Fast Example-based Surface Texture Synthesis via Discrete Optimization,” The Visual Computer: International Journal of Computer Graphics, Vol. 22, Issue 9, 2006, pp. 918-925.

A number of techniques, while not addressing texture synthesis per se, can be used in conjunction with texture synthesis to improve the realism of its results. For example, Bridson et al. describe mathematical models that simulate fluid flow. See the course entitled “Fluid Simulation,” International Conference on Computer Graphics and Interactive Techniques, ACM SIGGRAPH 2006, 2006, pp. 1-87. That course addresses incompressibility considerations, pertaining to the lack of compressibility in fluids. That course also addresses boundary conditions that affect the flow of fluids.

B. Illustrative Systems

B.1. Overview

FIG. 1 shows a motion synthesis system (MSS) 102 for simulating motion using a texture synthesis approach. To facilitate explanation, the MSS 102 will be described together with the example shown in FIGS. 2 and 3.

The MSS 102 accepts one or more exemplar images {Iᵢ}_{i=1:m} and a large-scale motion image L. Together, these images comprise input information. The MSS 102 produces synthesized output information on the basis of the input information.

The exemplar images describe small-scale motion to be duplicated within the output information. The exemplar images contain repetitive content of any nature. For example, some exemplar images may include regular patterns, other exemplar images may include patterns that are at least partially stochastic in nature, etc. In contrast, the large-scale image describes a large-scale motion to be represented in the output information, e.g., corresponding the flow of a material, the movement of herds or crowds, the large-scale movement of a single entity, and so on. In other words, the large-scale image describes a global or overarching movement to be represented in the output information. In one case, the large-scale image does not contain repetitive content, but it also may include repetitive content. The motion information within the exemplar images and the large-scale image can be represented in any manner, such as by using vector fields.

The exemplar images and the large-scale motion image may have smaller sizes than the output information. In one representative and non-limiting example, each exemplar image can have a size of 64×64 pixels, the large-scale image can have a size of 64×64 pixels, and the synthesized output image can have a size of 256×256 pixels. Further, in one example, the large-scale image may have a relatively low resolution.

FIG. 2 shows an example in which the MSS 102 receives a large-scale motion image 202 and a single exemplar image 204. In this representative case, the large-scale motion image 202 represents a main flow of a plume of smoke. The large-scale motion image 202 lacks repetitive content. The exemplar image 204 represents a motion that is derived from an original exemplar image 206. The original exemplar image 206 includes heart-shaped objects; hence, the exemplar image 204 includes heart-shaped motion patterns. The exemplar image 204 includes repetitive content by virtue of its repetition of the heart-shaped motion patterns. Any technique can be used to visualize the motion fields in the large-scale motion image 202 and the exemplar image 204, such as, without limitation, the line integral convolution (LIC) technique.

Returning to FIG. 1, the large-scale motion image and the exemplar images can originate from any sources 104. In one case, a user can use a manual technique to specify the large-scale motion image and/or the exemplar images. For example, a user can sketch out a large-scale motion field and/or small-scale motion fields using any technique. In another case, a user can record actual physical motion to provide the large-scale motion image and/or the exemplar images. For example, the user can capture a video of the movement of a crowd or herd to identify the large-scale motion field and/or the small-scale motion fields. In another case, a user can use an automated technique to generate the large-scale motion image and/or the exemplar images. For example, a user can apply a physics simulation algorithm or a procedural simulation algorithm to generate the large-scale motion field or the small-scale motion fields. The user can also use a combination of different techniques to generate the input information.

In one technique, an input image can be created in one form and then converted into another form to reveal motion information within the input image. For example, in FIG. 2, a user has provided an original exemplar image 206 that depicts heart-shaped objects using RGB color information. Functionality can be provided to convert this original exemplar image into the exemplar image 204 which reveals motion content. For example, the functionality can take the curl of the original exemplar image 206 to produce the exemplar image 204, e.g., by taking the curl of the magnitudes of the image pixels in the original exemplar image 206.

An input module 106 can receive the input information from any one of the above-described sources 104 or any combination of the above-identified sources 104. The input module 106 can store the input information in one or more stores 108, referred to in the singular for brevity.

A synthesis module 110 next operates on the input information to produce a synthesized motion image H. By way of overview, the synthesis module 110 performs texture synthesis on the exemplar images to populate an output field with the repetitive content contained in the exemplar images. The synthesis module 110 also uses the large-scale motion indicated in the large-scale image to produce the synthesized motion image. More specifically, the synthesis module 110 orients the small-scale motion described in the exemplar images within a global flow defined by the large-scale image. In one representative case, the synthesized motion image has high resolution compared to the large-scale motion image.

The synthesis module 110 can use any texture synthesis approach to create the synthesized motion image. In one technique, the synthesis module 110 uses any neighborhood search technique to identify matching content in the exemplar images and copy that matching content over to the synthesized motion image. In this case, however, instead of operating on color information, the synthesis module 110 operates on motion information. The following discussion will explain how the synthesis module 110 performs this task, and, in particular, how the synthesis module 110 addresses considerations which are particular to the case of motion information (in contrast to color information).

By way of overview, in one approach, the synthesis module 110 can perform synthesis by minimizing the following energy function:

$${E}_{t} ( x ; \{ {z}_{p} \} ) = {\sum }_{p ∈ {X}^{†}} {\vert {x}_{p -} {z}_{p} \vert}^{2} + O ( x ) \qquad ( 1 )$$

Here Eₜ measures local neighborhood similarity across a subset X^{†} of the output information x, and zₚ indicates the most similar input neighborhood to each output neighborhood xₚ. Equation (1) represented an energy function that can be solved by an iterative process, alternating between a neighborhood search operation (analogous to the M step in an EM algorithm), and a pixel assignment operation (analogous to the E step in an EM algorithm). The term O(x) corresponds to an additional energy term, associated with any one or more application-specific constraints (to be discussed below). The neighborhood search technique summarized here can be performed with respect to same-dimension synthesis (e.g., 2D-to-2D) or cross-dimension synthesis (e.g., 2D-to 3D).

FIG. 2 shows an example of a synthesized motion image 208 produced based on the large-scale motion image 202 and the exemplar image 204. In this case, the synthesis module 110 duplicates the heart-shaped motion pattern described in the exemplar image 204 within the synthesized motion image 208. In addition, the synthesis module 110 orients the heart-shaped motion patterns based on a global flow described in the large-scale motion image 202.

In the case of FIG. 2, the MSS 102 provides output information that has the same dimension as the input information. That is, the MSS 102 accepts an exemplar image 204 that has two dimensions (2D) and produces an output image that also has two dimensions. As will be described below, the MSS 102 can also be applied in a cross-dimensional scenario in which the exemplar images do not have the same dimensionality as the output information. For example, the MSS 102 can accept two or more 2D exemplar images and, based thereon, produce a 3D output image.

Returning to FIG. 1, a combination module 112 combines the synthesized motion image with the large-scale image to produce a combined image F. In performing this operation, the combination module 112 can apply a combination parameter ω. The combination parameter governs the extent to which the small-scale motion (associated with the exemplar images) is blended into the large-scale motion (associated with the large-scale image). FIG. 2 shows an illustrative combined motion image 210, represented in visual form using the LIC technique.

A post-processing module 114 optionally operates on the combined motion image F to produce a post-processed image (F′). In one case, the post-processing module 114 can modify the combined motion image to take account for physical phenomena that are not modeled by the texture synthesis operation. For example, the post-processing module 114 can modify the combined motion image to address the incompressibility of fluids. Alternatively, or in addition, the post-processing module 114 can modify the combined motion image to take account for boundary conditions. The post-processing module 114 can also perform post-processing to take account for fanciful effects that do not have any physics-based counterparts. Alternatively, or in addition, the MSS 102 can address one or more application-specific constraints (such as boundary conditions) within the texture synthesis operation performed by the synthesis module 110.

The combination module 112 and/or the post-processing module 114 (if used) can store the output information in one or more stores 116, referred to in the singular for brevity. An output module 118 displays the output information in the context of one or more applications. For example, the MSS 102 can provide output information in the context of a computer-implemented game application, a computer-implemented simulation application, a computer-implemented video enhancement or restoration application, and so on. No limitation is placed on the ways in which the MSS 102 can use the output information.

FIG. 3 shows the outcome of the processing performed by the MSS 102 on the large-scale motion image 202 and the exemplar image 204 of FIG. 2. Recall that the large-scale motion image 202 describes a plume of smoke, while the exemplar image 204 describes motion patterns derived from heart-shaped objects. An original density image 302 depicts the plume of smoke before texture synthesis has been applied. A transformed density image 304 depicts the effects of modulating the plume of smoke by the small-scale motion defined by the exemplar image 204. That is, the large-scale motion guides the global flow of the plume of smoke. The small-scale motion manifests itself in heart-shaped patterns within the plume of smoke, such as heart-shaped pattern 306.

In the scenario of FIG. 2, the MSS 102 has been used to graft a fanciful or cartoonish effect (heart-shaped movement) onto an otherwise physical phenomenon (a plume of smoke). In general, the large-scale motion can represent any realistic or fanciful effect; likewise, the small-scale motion can represent any realistic or fanciful effect. For example, the small-scale motion can simulate a physical phenomenon, such as local instances of turbulence within a flowing stream, and so on.

FIGS. 2 and 3 show a texture synthesis operation performed on a single frame of image information to provide the transformed density image 304. The transformed density image 304, in turn, can be part of an animation sequence that includes multiple frames. The MSS 102 can perform the same operations described above with respect to each frame of the animation sequence. When played, the animation sequence exhibits the motion-related behavior derived from the input information. For each frame, the MSS 102 can perform advection to initialize the texture synthesis operation (except for the first frame of the animation sequence); in advection, the results from a previous frame are carried over to a next frame.

In one mode, the MSS 102 can be used to generate texture synthesis in offline fashion for later presentation. In another approach, the MSS 102 can be used to perform texture synthesis and present the results of texture synthesis in real-time fashion. In the latter approach, the MSS 102 can dynamically react to changes in input information and/or controlling parameters.

In the above explanation, the MSS 102 was described as accepting a single large-scale motion image, e.g., the large-scale motion image 202 of FIG. 2. Although not shown, the MSS 102 can also accept multiple large-scale motion images. For example, the MSS 102 can combine the multiple large-scale motion images together in any manner to define a single motion vector field for use in guiding the texture synthesis operation.

The MSS 102 may confer one or more benefits. For example, the MSS 102 may provide a general and flexible approach for producing detailed motion. This characteristic ensues, for instance, from the ability of the MSS 102 to accept inputs from a variety of sources 104 (e.g., manually-specified data, automatically-specified data, captured data pertaining to physical events, and so on). The MSS 102 applies the same algorithm to any such diverse input information, contributing to the generality of the approach.

In addition, the MSS 102 may be easy to operate. This is because, for instance, the MSS 102 does not ask the user to manually annotate the input information or make other ad hoc guiding actions. The user simply selects one or more exemplar images and the large-scale image, any of which may describe relatively simple motion. The user may also optionally specify one or more controlling parameters (such as the combination parameter ω). The MSS 102 can produce visually rich and controllable output effects based on this relatively simple input information. In addition, the MSS 102 may also be computationally efficient in operation.

In addition, the MSS 102 can produce results that are difficult to achieve using other techniques, such as fanciful (non-realistic) effects. FIGS. 2 and 3 illustrate one such fanciful effect (heart-shaped detail motion patterns) which may be difficult to achieve using other techniques (such as procedural texturing or physics-based simulation).

In addition, the MSS 102 can interject the appearance of randomness into the output information, which contributes to the realistic effect. This feature naturally ensues from the use of texture synthesis, which introduces a random-like effect in its duplication of small-scale patterns.

The benefits identified above are representative. The MSS 102 can confer yet additional benefits.

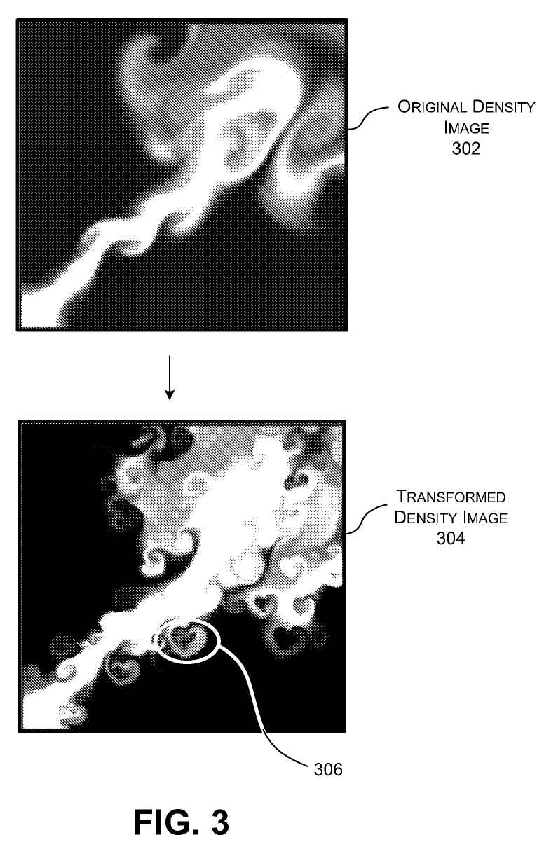

FIG. 4 shows an example in which the MSS 102 applies texture synthesis to a three dimensional (3D) object 402. In this approach, the MSS 102 can accept two 2D exemplar images (404, 406) in combination with a large-scale motion image (not shown). For example, the 2D exemplar images (404, 406) can correspond to different respective views of the object 402. For instance, the exemplar image 404 can describe a square-shaped swirl pattern for application to a top view of the object 402. The exemplar image 406 can describe a stripe-shaped detailed motion pattern for application to the side views of object 402. In other words, in this particular example, the exemplar images (404, 406) are applied to different orthogonal views of the object 402, corresponding to an x viewing perspective, a y viewing perspective, and a z viewing perspective. However, in general, there is no requirement that the exemplar images map to different orthogonal views.

The example of FIG. 4 represents a cross-dimensional scenario. This is because the MSS 102 accepts input information in the form of 2D exemplar images and a 2D large-scale image (not shown) and generates output information in the form of a 3D image. The use of multiple 2D exemplar images is expedient, as it is may be difficult to obtain a 3D exemplar image.

The MSS 102 operates on the input information using a cross-dimensional neighborhood search technique. Further details regarding this operation will be described below. By way of overview, for a particular output voxel, the MSS 102 can identify matching neighborhoods across different exemplar images. The MSS 102 can then combine the contributions of the matching neighborhood to produce the output voxel. The texture synthesis operation has the effect of integrating the motion patterns associated with different respective views.

In one case, the MSS 102 can apply different weights to the exemplar images when performing synthesis to improve the quality of the results. As a consequence of the weights, one or more of the views can be given a predominant effect in the synthesis. The user and/or the MSS 102 can select the favored view(s) based on any application-specific factor (or factors). For example, the MSS 102 can select a favored view to match a view which faces the viewer.

In the particular example of FIG. 4, the large-scale image and the exemplar images may combine to create an effect that can be metaphorically described as tornados having square cross sections. In another example (not shown), sinusoidal exemplar images can be assigned to one or more views of reed-like objects to create an undulating effect, which may be effective, for instance, in simulating swaying weeds within water. It may be difficult to achieve these results using alternative techniques (such as physics-based simulation or procedural texturing), without resorting to potentially complex and ad hoc modeling.

In one approach, the MSS 102 can be used to produce motion fields which “permeate” the entire 3D output volume. In another case, the MSS 102 can produce motion fields for selected parts of the 3D volume. The MSS 102 can dynamically synthesize additional parts of the 3D volume on an as-needed basis.

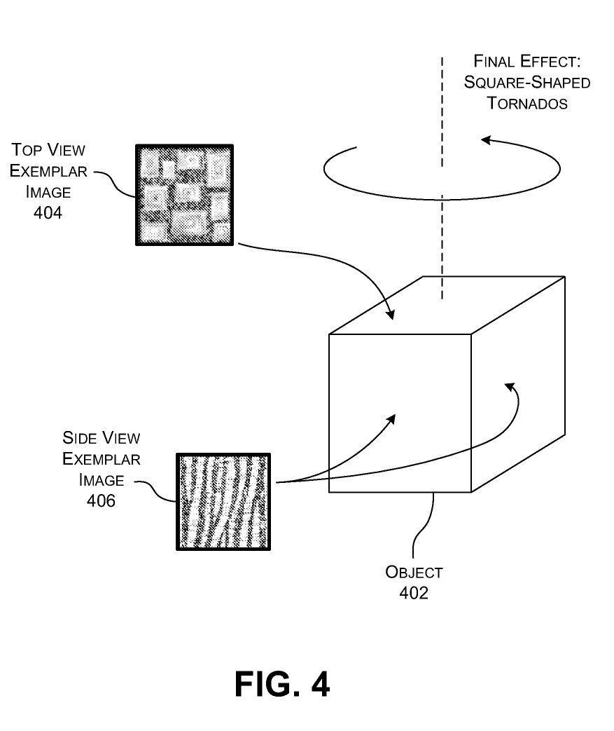

FIG. 5 shows an example in which the MSS 102 applies texture synthesis based on a single exemplar image 502. In this case, the texture synthesis is constrained by a boundary condition (where this boundary condition is based on a scenario set forth by Bridson et al., as cited above). The boundary condition corresponds to an object 504 which diverts a direction of material flow. In this case, the synthesis module 110 can combine the exemplar image 502 with a large-scale image (not shown) in the manner described above to produce a combined motion image. The post-processing module 114 can then apply processing which takes account for the presence of the boundary condition.

More specifically, a first image 506 shows motion flow around the object 504 without the effects of the small-scale motion (associated with the exemplar image 502). A second image 508 shows the motion flow around the object 504 with the contribution of the small-scale motion. The small-scale motion produced by the exemplar image 502 is particularly evident in a region 510 behind the object 504.

In general, the post-processing module 114 can perform any corrective action on the combined motion image based on any consideration. Alternatively, or in addition, the MSS 102 can integrate the processing of boundary conditions and other application-specific constrains into the preceding texture synthesis operation itself, as described in greater detail below.

B.2. Illustrative Implementation

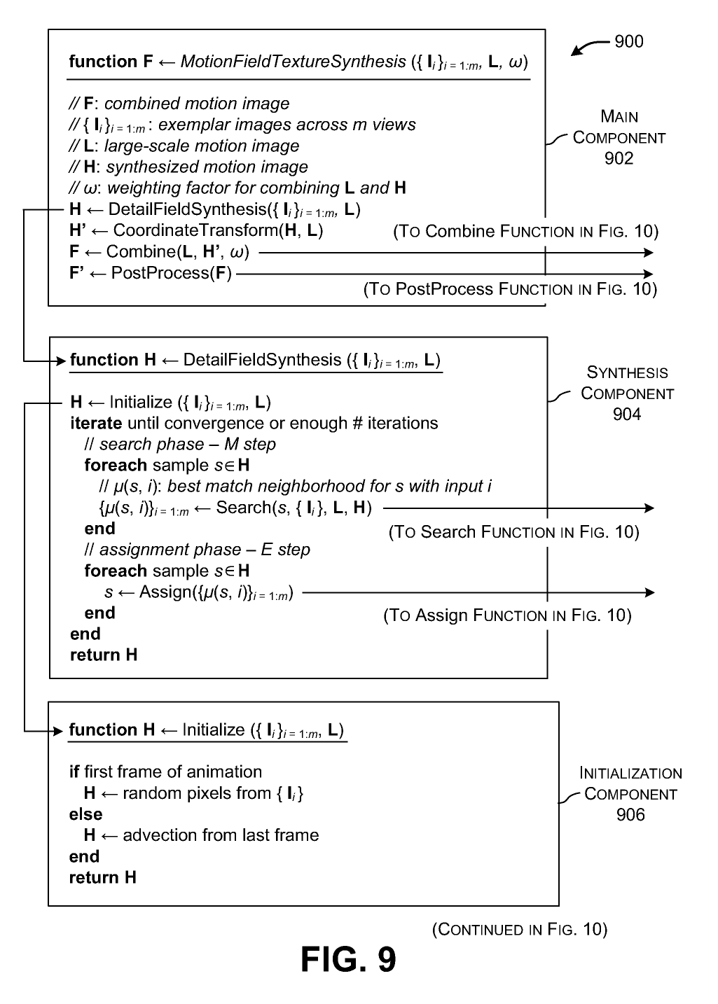

The remainder of Section B provides information regarding one implementation of the MSS 102 of FIG. 1. Namely, FIGS. 9 and 10 describe one representative process 900 that can be used to implement the features of the MSS 102. In this approach, motion information can be treated in a similar manner to color information. For example, motion vector information can be considered as akin to multi-channel color information. However, motion information includes particular features that are not shared by color information. These features introduce new complexity in performing texture synthesis on motion information. Before describing the process 900 of FIGS. 9 and 10 in detail, this section will describe provisions taken by the MSS 102 to address considerations associated with the processing of motion information (in contrast to color information).

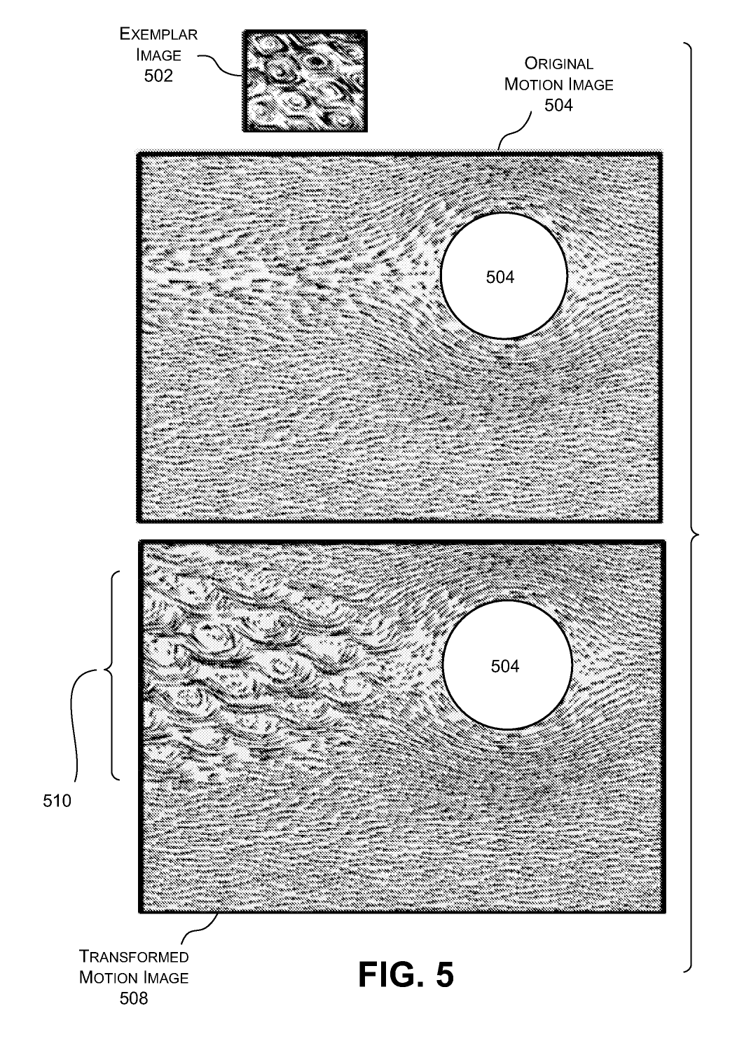

To begin with, FIG. 6 shows how the synthesis module 110 can perform coordinate transformation to take account for the processing of motion information. In this particular example, the MSS 102 accepts an exemplar image 602 that describes a small-scale swirl pattern. The MSS 102 also accepts a large-scale image that describes a global direction of flow. More specifically, FIG. 6 shows output information in which the direction of flow is described by diagonal motion flow vectors, such as representative motion flow vector 604.

The synthesis module 110 operates by performing texture synthesis with respect to local frames of reference defined by the motion flow vectors. In other words, the synthesis module 110 operates by orienting instances of the swirl-pattern in accordance with the global flow defined by the large-scale image. However, in the case of motion information, it is not enough to orient the output neighborhoods with respect to the motion flow vectors defined by the large-scale motion (unlike the case of texture synthesis performed on color information). This is because, for motion information, the synthesized vector field will still retain the values from the original input coordinate frame (associated with the exemplar image 602). For example, consider a point 606 in the output information. After synthesis, this point 606 retains a value associated with arrow 608 (associated with the original coordinate frame), which is incorrect. The correct value at this point corresponds to the arrow 610. The correct value is obtained by transforming the directly-synthesized arrow 608 by the local coordinate system, associated with the diagonal vector field.

To provide the correct values, the synthesis module 110 can transform the coordinate system for each output neighborhood in accordance with the flow direction established by the large-scale image. In one implementation, the synthesis module 110 can perform this transformation as a post-synthesis process, that is, after it performs texture synthesis. This means that the synthesis module 110 uses untransformed values during the texture synthesis operation. In this manner, during texture synthesis, untransformed values in the output information can be used to match untransformed values in the exemplar image(s).

In addition, motion information may impact human perceptions in a different manner than color information. This issue, in turn, may have different implications in the manner in which the texture synthesis is performed. For example, for color information, the literature indicates that it is more appropriate to achieve local coherence than address occasional high frequency discontinuities. In other words, for color information, it is tolerable to accept discontinuities in favor of reducing blur and noise. However, for motion information, the opposite rule may hold true. For motion information, low frequency blur or noise is more tolerable than high frequency discontinuity. To achieve this result, the synthesis module 110 can apply a least-squares-based texture optimization technique, rather than a k-coherence enhanced version of the technique. However, as will be discussed below, the synthesis module 110 can also apply a k-coherence technique to expedite the texture synthesis operation.

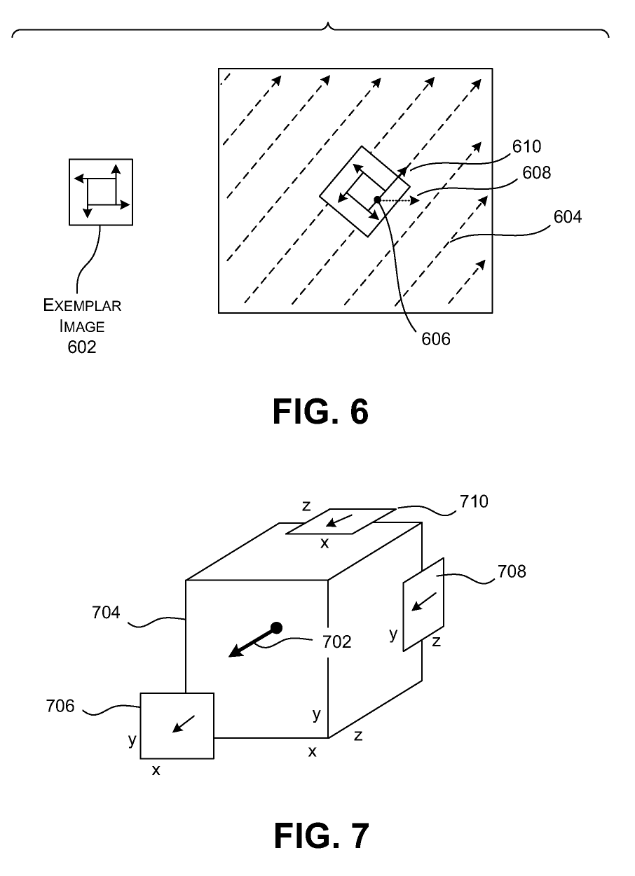

FIG. 7 shows how the synthesis module 110 can perform vector projection to take account for the processing of motion information. In this example, the synthesis module 110 accepts two or more exemplar images that describe small-scale motion associated with different views. The synthesis module 110 uses these exemplar images, together with a large-scale image, to synthesize 3D output information. The synthesis module 110 can apply a multi-dimensional neighborhood search technique to perform texture synthesis, as modified in the manner described below.

In a 2D-to-3D synthesis algorithm, the synthesis module 110 matches up neighborhoods centered around each 3D output voxel with neighborhoods from several 2D exemplar images (which are associated with different orientations or views). Specifically, the synthesis module 110 can use a two-phase operation to determine the value of each output voxel s, as summarized above in Section B.1. In a search phase, the synthesis module 110 can build m neighborhoods {N(s, i)}_{i=1:m} centered at s with orientations matching each one of the m input exemplars {Iᵢ}_{i=1:m}. In one representative case, for example, the three input views are perpendicular to the three coordinate axes of the output volume. The synthesis module 110 then finds a matching (e.g., most similar) neighborhood μ(s, i) for N(s, i) from Iᵢ for each exemplar image i. In an assignment phase, the synthesis module 110 combines the centers of the matches {μ(s, i)}_{i=1:m} to yield the final value for the output voxel s. The synthesis module 110 can perform this combination using weighted least squares, k-coherence, or some other technique. The synthesis module 110 repeats the above-described operations one or more times until convergence is achieved or a prescribed number of iterations is reached.

Color information is invariant with respect to different 2D views, but motion information is not. Hence, motion information is subject to projection whereas color information is not. This issue affects both the search phase and the assignment phase of the texture synthesis operation performed by the synthesis module 110.

To illustrate this point, consider the 3D output vector information 702 in FIG. 7 within an output volume 704. Each of the three 2D input views can only “see” corresponding projected components of the 3D vector information 702. That is, an x/y plane 706 is affected by certain components of the 3D output vector information 702; a y/z plane 708 is affected by other components of the 3D output vector information 702; and an x/z plane 710 is affected by other components of the 3D output vector information 702.

To address this issue, in the search phase, after building the output neighborhoods {N(s, i)}, the synthesis module 110 projects the vector components with respect to each one of the input views i before conducting the match operation. For example, assume that the exemplar images correspond to three views that are aligned with three orthogonal coordinate axes. If N(s, 1) corresponds to a view perpendicular to the x-axis in FIG. 7, the synthesis module 110 operates by zeroing out the x components in N(s, 1); as a consequence, the synthesis module 110 uses only the y/z components for performing the match operation. This amounts to dropping one of the 3D vector components.

In the assignment phase, each input match μ(s, i) contributes only selected vector components to the output voxel s. For example, if a direct average is to be performed from the three orthogonal views in FIG. 7, the synthesis module 110 can define the value of the output voxel s as follows:

$${s}_{x} = \frac{{μ ( s , 2 )}_{x} + {μ ( s , 3 )}_{x}}{2} \\ {s}_{y} = \frac{{μ ( s , 3 )}_{y} + {μ ( s , 1 )}_{y}}{2} \\ {s}_{z} = \frac{{μ ( s , 1 )}_{z} + {μ ( s , 2 )}_{z}}{2} \qquad ( 2 )$$

Here, sₓ, s_{y}, and s_{z} refer to different components of the output voxel s. In Equation (2), the synthesis module 110 performs an averaging operation in the assignment phase, but it also possible to combine the results from different views using other algorithms, such as by performing a weighted average in combination with a histogram matching operation. However, it is observed that more complex algorithms are not necessary to produce satisfactory results; this characteristic reflects another perceptual difference between motion information and color information.

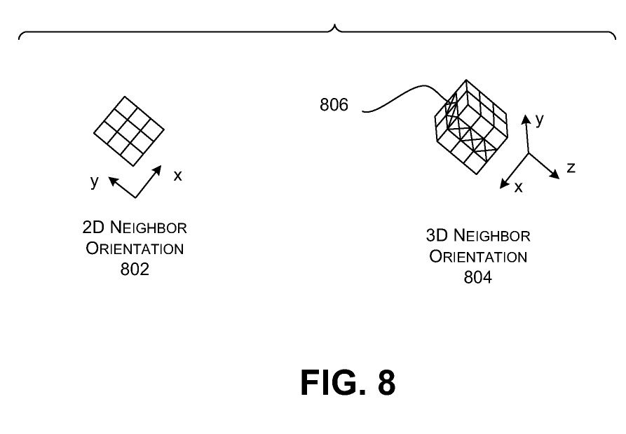

FIG. 8 complements the discussion of FIG. 6 by showing how the synthesis module 110 can establish local frames of reference. The local frames of reference define how the output neighborhoods are oriented in performing texture synthesis. In one case, the synthesis module 110 can align local coordinate frames with a global coordinate system. This provision might be sufficient for stochastic texture patterns. However, for more structured patterns, the synthesis module 110 can achieve more natural-looking results by aligning the local frames with the large-scale motion field defined by the large-scale motion image L.

As shown in the first example 802, in 2D, a local frame is completely defined by the large-scale motion image. Namely, the synthesis module 110 can define the x-axis so that it follows the large-scale motion flow. The synthesis module 110 can then define the y-axis so that it is rotated 90 degrees from x-axis.

As shown in the second example 804, in 3D, the large-scale motion field only specifies one of the three coordinate axes. This means that the orientations of the other two axes are under-constrained. In general, the synthesis module 110 can provide satisfactory results regardless of the rules used to define the two remaining axes, providing that the resulting local frames are spatially and temporally coherent. In one approach, the synthesis module 110 can define the remaining axes based on application-specific considerations. For example, the synthesis module 110 can define the remaining axes based on a density gradient associated with smoke. Alternatively, or in addition, the synthesis module 110 can allow a user to manually specify the remaining axes. For example, the synthesis module 110 can allow the user to specify vector flow information by annotating an input image at selected locations; the synthesis module 110 can then expand this vector flow information based on known interpolation techniques.

As stated, the local frames define the framework in which the synthesis module 110 can perform its operation. In the case of 2D, the synthesis module 110 can sample the output neighborhoods based on respective per-sample two-dimensional local frames. For 3D, the synthesis module 110 can first process an output neighborhood according to an x/y local frame. The synthesis module 110 can then process a slice, such as slice 806, for an input view perpendicular to the x/y axes.

Now advancing to FIGS. 9 and 10, these figures together show a process 900 that can be used to implement the MSS 102 of FIG. 1. A main component 902 describes the principal operations in the process 900. In a first operation, the MSS 102 forms a synthesized motion image H based on one or more exemplar images {Iᵢ}_{i=1:m} and a large-scale motion image L. That is, for the case of 2D-to-2D synthesis, the process 900 accepts a single exemplar image I; in the case of 2D-to-3D synthesis, the process 900 can accept plural exemplar images {Iᵢ}. In a second operation, the MSS 102 performs coordinate transformation to address the issues discussed above in connection with FIG. 6. This operation produces coordinate-transformed synthesized motion image H′. In a third operation, the MSS 102 combines the synthesized motion image (H′) with the large-scale motion image L to produce a combined motion image F. In a final optional operation, the MSS 102 performs post-processing on the combined motion image F to produce a post-processed image F′.

A synthesis component 904 describes the operations performed by the synthesis module 110. In a first operation, the MSS 102 initializes the synthesized motion image H by invoking an initialization component 906. The initialization component 906 performs a first type of initialization on the first frame in an animation sequence and a second type of initialization for subsequent frames. For the first type, the initialization component 906 can initialize H by randomly copying pixels from the input exemplar(s) {Iᵢ}. More specifically, if the synthesized motion image H has the same dimension as a single exemplar image (as in 2D-to-2D), then the initialization component 906 can randomly select pixels from this exemplar image for use in initializing H. If the synthesized motion image H has a different dimension than the exemplar images, then the initialization component 906 can randomly select neighborhoods from different exemplar images {Iᵢ} and blend them together via the assignment algorithm (described above), taking into account the projection considerations described above.

Consider next subsequent frames of an animation sequence. Here, the MSS 102 initializes the synthesized motion image H by advecting H from the previous frame based the large-scale motion information obtained from the large-scale motion image L.

Returning to the synthesis component 904, the MSS 102 next commences an iterative texture synthesis operation, e.g., based on the energy minimization approach summarized above in connection with Equation (1). Each iteration of the texture synthesis operation includes a search phase and an assignment phase. The search phase is analogous to the M step in an EM algorithm, while the assignment phase is analogous to the E step in the EM algorithm. Referring now to FIG. 10, a search component 1002 and a match component 1004 implement the search phase, while an assign component 1006 implements the assignment phase. In the search component 1002, the MSS 102 samples a neighborhood around an output voxel s, considering both the orientation of an exemplar image Iᵢ and the local frame defined by the large-scale motion image L at the location of s. The MSS 102 then performs a projection operation to take account of the projection considerations described above in connection with FIG. 7. The MSS 102 then selects matching neighborhoods μ{(s, i)}_{i-i:m} using a match component 1004.

In one case, the match component 1004 finds the most similar neighborhood in Iᵢ associated with N(s, i) using a tree search algorithm. In another case, the match component 1004 finds the most similar neighborhood in Iᵢ associated with N(s, i) using a k-coherence algorithm. The match component 1004 can use other approaches to find the most similar neighborhood.

The assign component 1006 assigns a value to an output voxel s. In one case, the assign component 1006 selects a value for s by averaging the centers of the matching neighborhoods {μ(s, i)}. In another case, the assign component 1006 selects a value for s by selecting a k-coherence candidate most similar to the average of the centers of {μ(s, i)}.

The options associated with the match component 1004 and the assign component 1006 reflect different approaches to accelerate the processing of the synthesis component 904. More specifically, the neighborhood search operation that is performed in the match component 1004 represents the main performance bottleneck of the process 900 as a whole, where the search time is proportional to the sizes of the exemplar images. As stated, the match component 1004 can perform a tree-type search technique. This technique may be appropriate for smaller exemplar images. However, this technique may become increasingly time-consuming with larger exemplar images. To address this situation, the match component 1004 can employ the k-coherence search technique. The k-coherence search technique offers constant search time per output sample.

The k-coherence search technique operates as follows for the case of 3D texture synthesis. The synthesis component 904 can store, for each output voxel s, the indices of the matches from the exemplar images. During the search phase, the synthesis component 904 can use the k-coherence technique instead of tree search to find the matching neighborhoods. During the assignment phase, the synthesis component 904 can take the candidate that is closest to the average of the centers of the matches, essentially minimizing the neighborhood difference energy function, while still keeping the list of indices of the matches from the exemplar images.

Continuing with the explanation of the process 900, a combine component 1008 combines the candidate-transformed synthesized motion image H′ with the large-scale image L to produce a combined motion image F. In one case, the combine component 1008 can perform this task by multiplying the synthesized motion image H′ by a combination parameter ω. The combine component 1008 then adds the product H′×ω to the large-scale motion image L. In performing these operations, the combine component 1008 can also perform upsampling or downsampling to provide the desired size of the output information.

A user can tune the combination parameter ω to govern the amount of detailed motion that is added to the large-scale motion. In one case, the combination parameter ω reflects a global constant that applies to the entire combined motion image F. In another case, the combination parameter ω varies for different regions of the large-scale motion image L. For example, the combine component 1008 can vary the combination parameter ω based on any characteristic (or characteristics) of the large-scale motion image L, such as the kinetic energy or vorticity of the large-scale motion image L, etc.

Although not mentioned in the description above, the process 900 can perform texture synthesis with respect to multiple resolutions of the input information, such as two or three different resolutions. The multiple resolutions may define a pyramid of image information. This provision can be used to more effectively capture texture detail of different sizes when performing texture synthesis. The MSS 102 can also allow the user to specify the number of resolutions that are used, the number of iterations that are performed, and/or other controlling parameters.

A post-processing component 1010 performs post-processing on the combined motion image F to produce a post-processed image F′. As noted above, the post-processing functionality can perform any operation on the combined motion image F to take account for any application-specific constraint. In general, post-processing may be warranted because the MSS 102 produces the combined motion image F via texture synthesis, rather than the physics-based simulation of natural phenomena. In one case, the post-processing component 1010 modifies the combined motion image F to take account for the incompressibility of a material (e.g., fluid) being simulated. In another case, the post-processing component 1010 modifies the combined motion image F to take account of a boundary condition. In still another case, the post-processing component 1010 modifies the combined motion image F to take account for both incompressibility and a boundary condition.

As to incompressibility, the exemplar images {Iᵢ} and detailed motion image L may be both incompressible. In this case, the synthesized motion image H can be considered to be visually incompressible, even though it may not be so in actuality. (Texture synthesis, by matching spatial neighborhoods, does not tend to alter the divergence of the motion fields to a great extent.) If strict incompressibility is desired, the post-processing component 1010 can perform Helmholtz-Hodge decomposition on the combined motion image F before rendering. This type of decomposition is described, for instance, in Tong et al., “Discrete Multiscale Vector Field Decomposition,” Proceedings of ACM SIGGRAPH 2003, Volume 22, Issue 3, 2003, pp. 445-452.

As to boundary conditions, assume that the MSS 102 is called upon to create a realistic depiction of a material which is constrained by some boundary condition, such as a boundary condition associated with the object 504 shown in FIG. 5. To satisfy such a boundary condition, the post-processing component 1010 may attempt to ensure that the normal components of the combined motion image F match the normal components of the shared boundaries. The post-processing component 1010 can achieve this result by modulating the combined motion image F as follows:

F=F+β×(b−n) (3)

Here, n is the component of F normal to the boundary, b is the normal component of the boundary, and β f: is a weight field that is 1 at the boundary and gradually decreases to zero as a function of the distance from the boundary. In essence, Equation (3) performs a smooth blending of the normal components between F and the boundary.

The above-described approach operates directly on the combined motion image F, rather than modulating potential fields. However, a direct blending of the motion field might violate a constraint pertaining to incompressibility. To simultaneously enforce constraints pertaining to incompressibility and boundary conditions, the post-processing component 1010 can convert the combined motion image F into a potential field ψ. The post-processing component 1010 can then enforce a boundary condition constraint by modulating ψ, rather than directly modulating F. The post-processing component 1010 can derive a final incompressible motion image F′ as F′=∇×ψ, where “∇×” represents the curl operator.

More specifically, given an input vector field v, the approach aims to find a potential field that satisfies the following aims: (1) the vector field ∇×ψ derived from ψ is to be as similar to v as possible; and (2) ψ (and the derived vector field Δ×ψ) is to be smooth. These conditions can be formulated as an energy minimization problem as follows:

E(ψ, v)=|∇×ψ−v|²+α|∇²ψ|² (4)

Here, ψ represents the potential field that the approach aims to solve (which is a scalar in 2D or a 3-component vector in 3D), “∇×” represents the curl operator, and ∇² represents the Laplacian operator (∇²≡∇·∇, representing the divergence of the gradient). This energy function has two terms. The first term is a soft constraint enforcing similarity to v, while the second term is a smoothness/regularization term. These terms are weighed by a factor α, which determines how much smoothness is desired.

However, since the Equation (4) pertains to derivatives of ψ, it is under-constrained. To address this issue, the post-processing component 1010 can impose two constraints over ψ: (1) 0≦ψ≦1, ∀ samples; and (2) ψ=0.5, ∀ boundary samples. The first constraint clamps the range for potential color values. The second constraint ensures the uniqueness of an optimal solution, and leads to a gray background color satisfying a toroidal boundary condition. With these constraints, the task of minimizing Equation (4) becomes a quadratic programming problem, having a solution that can be solved.

In application, for scenarios that involve both incompressibility and boundary condition constraints, the post-processing component 1010 can input the combined motion image F into Equation (4), find the ψ that minimizes E(ψ, F), modulate ψ for boundary conditions, and take F′=∇×ψ as a final processed motion image.

Instead of addressing boundary conditions in a post-processing operation, or in addition to this post-processing operation, the synthesis module 110 can address boundary conditions as an integral part of its synthesis operation. One way of implementing such an approach is described below.

As stated above, to address a boundary condition, the MSS 102 attempts to ensure that the normal components of F match the normal components of the shared boundaries. The synthesis component 904 can achieve this result by performing constrained texture synthesis. By analogy, in the case of color information, constrained texture synthesis can be used to fill in missing content (e.g., a “hole”) within a color image, or to replace an object within a color image. In this context, texture synthesis proceeds by maintaining the constrained portions of the color image fixed while attempting to synthesize textures over a target region associated with the constrained portions. For example, the constrained portions may correspond to the boundary of a hole in the color image. In this manner, a newly synthesized portion of the color image resembles the exemplary image(s) and also remains consistent with the constrained portions.

The synthesis component 904 operates on motion information by also maintaining parts of the output information fixed; but, again, the approach is modified based on differences between color information and motion information. For instance, unlike color information in which the entire pixel value serves as a constraint, boundary conditions for motion information often involve only a specific vector component (e.g., that component normal to a boundary). This characteristic is related to the projection-related issue described above in connection with FIG. 7.

To address this issue, the synthesis component 904 can selectively match appropriate sub-vector components of the boundaries during the synthesis process. Specifically, the synthesis component 904 can operate based on a modified version of Equation (1), e.g., by adding the following constraint energy term Eₙ to Eₜ:

$${E}_{n} ( x ) = {\sum }_{p ∈ X} {λ}_{p} {\vert {x}_{p}^{n} - {b}_{p} \vert}^{2} \qquad ( 5 )$$

Here, x refers to the output motion information, xₚⁿ refers to the sub-vector component at sample p corresponding to the boundary direction (e.g., normal to a wall), b refers to the specified boundary condition (e.g., 0 velocity normal to a wall), and λ refers to a Gaussian weighting function (which peaks at the boundary and attenuates as a function of the distance from the boundary). This equation enforces boundary conditions via a soft constraint as an additional energy term over Equation (1). This approach may have certain advantages over a hard constraint approach. For instance, the soft constraint approach may provide better synthesis quality than the hard constraint approach. And it may be more effective in dealing with multi-resolution synthesis (where hard boundary constraints may not apply at lower resolutions). In addition, since Eₙ formulates a quadratic energy term, the combined energy function Eₙ+Eₜ can be solved via the search/assignment iterative process illustrated in FIGS. 9 and 10. In one implementation, A can have a wider span for lower resolutions and a sharper span for higher resolutions to produce desired synthesis quality.

As yet another alternative approach, for the case of 2D-to-2D-type synthesis, the MSS 102 can synthesize motion fields that are known to be incompressible by converting the exemplar images {Iᵢ} into potential fields {ψᵢ} via the process described above. The MSS 102 can then perform texture synthesis on {ψᵢ} to produce an output ψₕ, and then derive the synthesized motion image as ∇×ψₕ. (For 2D-to-2D synthesis, both the input ψᵢ and ψₕ are scalar-valued 2D functions, and thus ψₕ can be directly texture-synthesized from ψᵢ.) This alternative approach may have benefits compared to the direct synthesis of motion fields. Namely, since ψ is a scalar-valued function, the MSS 102 can potentially synthesize ψ in a more expedient manner compared to vector-valued motion fields. Further, in this formulation, the MSS 102 may be able to more efficiently enforce both incompressibility and boundary condition constraints.

C. Illustrative Processes

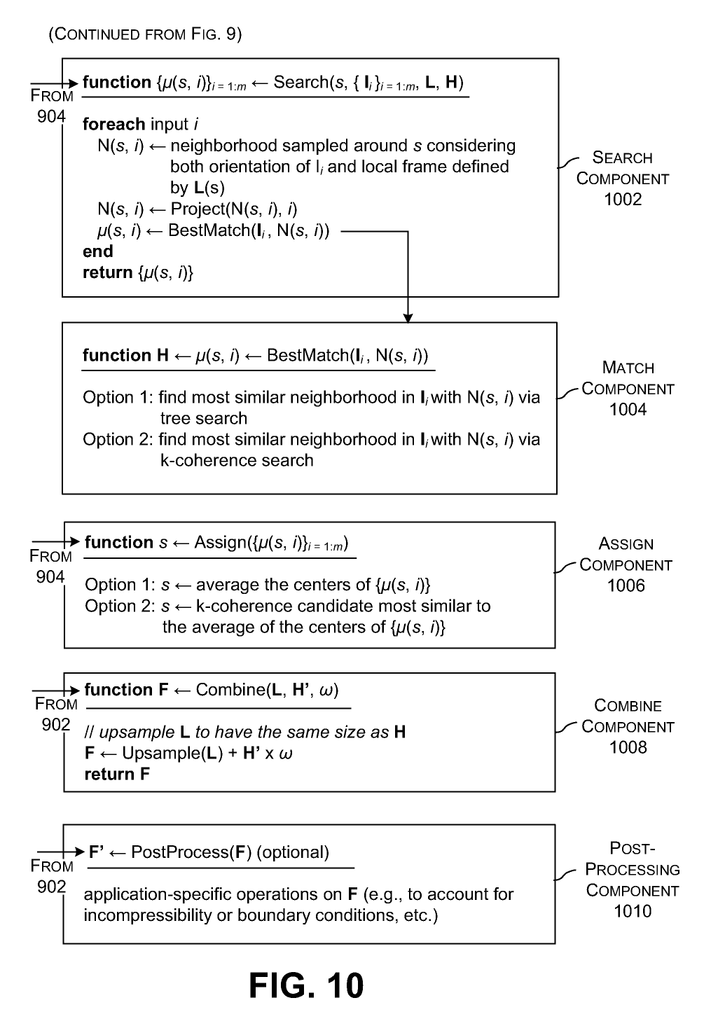

FIG. 11 shows a procedure 1100 which summarizes the operation of the MSS 102 of FIG. 1 in the flowchart form. Since the principles underlying the operation of the MSS 102 have already been described above, certain operations will be addressed in summary fashion in this section.

In block 1102, the MSS 102 receives a large-scale motion image L.

In block 1104, the MSS 102 receives one or more exemplar images {Iᵢ}_{i=1:m}.

In block 1106, the MSS 102 generates a synthesized motion image H based on the large-scale motion image L and the exemplar image(s) {Iᵢ}.

In block 1108, the MSS 102 combines the synthesized motion image H with the large-scale motion image L to produce a combined motion image F.

In block 1110, the MSS 102 optionally performs post-processing on the combined motion image F to address application-specific constraints, to generate a post-processed image F′. Alternatively, or in addition, the MSS 102 can address one or more application-specific constraints in the synthesis operation (block 1106).

D. Representative Processing Functionality

FIG. 12 sets forth illustrative electrical data processing functionality 1200 that can be used to implement any aspect of the functions described above. With reference to FIG. 1, for instance, the type of processing functionality 1200 shown in FIG. 12 can be used to implement any aspect of the MSS 102. In one case, the processing functionality 1200 may correspond to any type of computing device that includes one or more processing devices.

The processing functionality 1200 can include volatile and non-volatile memory, such as RAM 1202 and ROM 1204, as well as various media devices 1206, such as a hard disk module, an optical disk module, and so forth. The processing functionality 1200 also includes one or more general-purpose processing devices 1208, as well as one or more special-purpose processing devices, such as one or more graphical processing units (GPUs) 1210. The processing functionality 1200 can perform various operations identified above when the processing devices (1208, 1210) execute instructions that are maintained by memory (e.g., RAM 1202, ROM 1204, or elsewhere). More generally, instructions and other information can be stored on any computer readable medium 1212, including, but not limited to, static memory storage devices, magnetic storage devices, optical storage devices, and so on. The term computer readable medium also encompasses plural storage devices. The term computer readable medium also encompasses signals transmitted from a first location to a second location, e.g., via wire, cable, wireless transmission, etc.

The processing functionality 1200 also includes an input/output module 1214 for receiving various inputs from an environment (and/or from a user) via input modules 1216 (such as one or more key input devices, one or more mouse-type input devices, etc.). The input/output module 1214 also provides various outputs to the user via output modules. One particular output mechanism may include a presentation module 1218 and an associated graphical user interface (GUI) 1220. The processing functionality 1200 can also include one or more network interfaces 1222 for exchanging data with other devices via one or more communication conduits 1224. One or more communication buses 1226 communicatively couple the above-described components together.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An electrical motion synthesis system for producing digital images that simulate motion, comprising:
an input module configured to receive electrical input information and store the electrical input information in a store, the electrical input information comprising:
a large-scale motion image that describes large-scale motion; and
at least one exemplar image that describes small-scale motion;
a synthesis module configured to generate a synthesized motion image by using a texture synthesis approach to duplicate the small-scale motion described in said at least one exemplar image, as guided by the large-scale motion described in the large-scale motion image;
a combination module configured to combine the synthesized motion image with the large-scale motion image to produce a combined motion image, the combined motion image presenting the large-scale motion as modulated by the small-scale motion; and
an output module configured to display the combined motion image within a context of a computer-implemented application that simulates motion.

2. The electrical motion synthesis system of claim 1, wherein the large-scale motion image describes a large-scale flow of a material.

3. The electrical motion synthesis system of claim 1, wherein the large-scale motion image describes a large-scale movement of a population of entities.

4. The electrical motion synthesis system of claim 1, wherein said at least one exemplar image is produced by transforming one or more original exemplar images into a form that reveals motion associated within said one or more original exemplar images.

5. The electrical motion synthesis system of claim 1, wherein the texture synthesis approach used by the synthesis module applies a neighborhood search technique to duplicate the small-scale motion.

6. The electrical motion synthesis system of claim 5, wherein the synthesis module is configured to orient instances of the small-scale motion within a flow described by the large-scale motion, and wherein the synthesis module is configured to modify coordinates associated with the instances of the small-scale motion to compensate for the orienting of the instances.

7. The electrical motion synthesis system of claim 5, wherein said at least one exemplar image comprises two or more exemplar images, wherein each exemplar image is associated with a different respective view of an object to be simulated.

8. The electrical motion synthesis system of claim 7, wherein the synthesis module is configured to determine motion vector components that selectively contribute to different respective views, and wherein the synthesis module is configured to modify an operation of the neighborhood search technique based on the motion vector components.

9. The electrical motion synthesis system of claim 1, wherein the combination module is configured to use a combination parameter to control an extent to which the small-scale motion affects the large-scale motion.

10. The electrical motion synthesis system of claim 1, further comprising a post-processing module configured to modify the combined motion image based on at least one application-specific constraint.

11. The electrical motion synthesis system of claim 10, wherein the application-specific constraint pertains to incompressibility of a phenomenon being simulated.

12. The electrical motion synthesis system of claim 1, wherein the synthesis module is configured to generate the synthesized motion image by iteratively minimizing an energy function.

13. The electrical motion synthesis system of claim 12, wherein the energy function includes an energy term associated with a boundary condition constraint.

14. A computer-implemented method for producing digital images that simulate motion, comprising:
receiving, using an input module, electrical input information and storing the electrical input information in a store, the electrical input information comprising:
a large-scale motion image that describes large-scale motion; and
at least one exemplar image that describes small-scale motion;
generating, using a synthesis module, a synthesized motion image by using a texture synthesis approach to duplicate the small-scale motion described in said at least one exemplar image, as guided by the large-scale motion described in the large-scale motion image, the texture synthesis approach applying a neighborhood search technique to duplicate the small-scale motion;
combining, using a combination module, the synthesized motion image with the large-scale motion image to produce a combined motion image, the combined motion image presenting the large-scale motion as modulated by the small-scale motion; and
displaying, using an output module, the combined motion image within a context of a computer-implemented application that simulates motion,
said synthesizing being operative to perform coordinate transformation and motion vector projection to take account for application of the texture synthesis approach to motion information.

15. The computer-implemented method of claim 14, wherein said synthesizing comprises duplicating the small-scale motion by orienting instances of the small-scale motion within a flow described the large-scale motion, and wherein the coordinate transformation comprises modifying coordinates associated with the instances of the small-scale motion to compensate for the orienting of the instances.

16. The computer-implemented of claim 14, wherein the motion vector projection comprises:
determining motion vector components that selectively contribute to different respective views; and
modifying the neighborhood search technique based on the motion vector components.

17. A computer readable storage medium for storing computer readable instructions, the computer readable instructions providing an electronic motion synthesis system when executed by one or more processing devices, the computer readable instructions comprising:
a logic component configured to generate a synthesized motion image by using a texture synthesis approach to duplicate small-scale motion described in at least one exemplar image, as guided by large-scale motion described in a large-scale motion image; and
a logic component configured to combine the synthesized motion image with the large-scale motion image to produce a combined motion image, the combined motion image presenting the large-scale motion as modulated by the small-scale motion.

18. The computer readable storage medium of claim 17, wherein the logic component configured to synthesize is configured to perform coordinate transformation and motion vector projection to take account for application of the texture synthesis approach to motion information.

19. The computer readable storage medium of claim 17, wherein the logic component configured to synthesize is configured to generate the synthesized motion image by iteratively minimizing an energy function.

20. The computer readable storage medium of claim 17, wherein the logic component configured to combine is configured to use a combination parameter to control an extent to which the small-scale motion affects the large-scale motion.
